(19) United States
(12) Patent Application Publication
(10) Pub. No.: US 2003/0155055 A1
(43) Pub. Date: Aug. 21, 2003

(54) Tire balancing using coated beads

(76) Inventor: Roger Leblanc, Georgetown (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/221,560

(22) PCT Filed: Dec. 11, 2000
(86) PCT No.: PCT/CA00/01488

(51) Int. Cl. B29D 30/06; F16F 15/32; C09K 3/00; C03C 12/00

(52) U.S. Cl. 152/154.1; 156/110.1; 156/75; 501/32; 501/33; 252/1

(57) ABSTRACT

A vehicle tire balancing material comprising beads (1) formed from a first material (1′) having a higher tribo-electric work function, the beads (1) further having a permanent coating (1″) formed from a second material having a lower tribo-electric work function.

### BACKGROUND OF THE INVENTION

1. Technical Field

This invention relates to materials used to balance tires, and especially to balancing materials which attain a controlled amount of static electricity charge during use of the tire (whilst rubbing against the inner liner of the tire).

2. Background Art

Tire balance is important for vehicle ride and stability and for customer satisfaction as well. Tires, wheels, rims, brake drums, rotors and hubs are all manufactured to a close tolerance for roundness, shape and balance. Nevertheless, by assembling all these tolerances together, the probability of this assembly being out of balance is high. Wheel imbalance causes forces that result in vibration through the vehicle's steering, suspension and body. Imbalance is the cause of the majority of vibration complaints.

One method of solving tire imbalance is to use a free-flowing balancing material within the imbalanced tire. The material is first introduced at mounting of a tire on a rim or into an already mounted tire. The tire retains proper balance simply because the free-flowing material, the minuscule individual elements making up the material, inside the tire are distributed by centripetal forces generated when the wheel is rotating in such a way that they even out the heavy spot or heavy side in the tire assembly. Glycol and fibres were first used about thirty years ago.

In the case of a rotating tire and wheel, a heavy spot creates a force away from the tire, but because it is anchored by the axle, an opposite force is created within the tire as the forces flex the suspension. This will draw a sufficient quantity of the balancing material in the direction of the opposite force until the heavy spot is neutralized. In currently available material, the remaining balancing material spreads itself evenly around the inside of the tire, the material then remains in place held by the centripetal forces which press the material against the inside of the tire (the liner of the tire). When the vehicle stops, the conventional material falls away from its neutralizing position on the liner and falls to the bottom of the tire, and returns to a neutralizing position when the vehicle re-commences motion at highway speeds. Therefore, the whole process of re-balancing must recommence after every stop, and a certain vibration will be felt in the vehicle before the balancing is completed once more.

U.S. Pat. No. 5,766,501 to Heffernan et al. is one such traditional balancing material that works in the conventional manner described above. In this disclosure, Heffernan teaches a balancing material having a composition to reduce friction of the overall balancing material to ensure the material retains free-flowing characteristics when installed into a tire. The composition disclosed therein still, however, has some apparent drawbacks. Unfortunately, the constant “on the liner” and “off the liner” motion of conventional balancing materials causes problems; for instance, some of the currently available balancing materials deteriorate through this constant “on”-“off” motion into dust particles. This deterioration, in turn, causes mounting and dismounting problems for tire installers as the resulting dust is undesirable, because the dust leaves a coat on the wheel and the tire mounting surface. Further still, the dust may clog the tire valve seat thereby possibly causing an air leak. The end result is that conventional balancing materials do not produce a constantly balanced tire, as they have to recommence the re-balancing process after every stop. During the gradual time the material is relocating to or from the balancing positions, the tire is out of balance and vibration is induced.

Another problem with currently available balancing materials, is that the materials may be abrasive in nature. The abrasive characteristic of currently available materials along with the on and off the liner action of the materials causes undesirable wearing down from the inside of the tire.

The absorption of moisture is another problem facing currently available materials. When the material absorbs moisture, the material tends to clump together. As a result of this moisture clumping, conventional materials tend not to position themselves in correct neutralizing/counterbalancing positions, or only partly achieving the correct positions, because the material cannot easily divide out for the balancing.

Further still, another problem encountered with some currently available materials, is that they sometimes react with the wheel material. One such traditional material has brass tracings that may react with aluminum wheels.

A tire balancing material made of glass beads, either alone or in combination with small amounts (up to about 1% by volume) of lubricant, is disclosed in U.S. Pat. No. 6,128,952 (LeBlanc). The lubricant is preferably silicone. When a tire is inflated and is set in motion the glass beads migrate within the tire so as to balance any imbalance in the tire. It is the inventors belief that, after installation and during the initial rotations of the tire, the glass beads will charge by tribo-electrification or contact electrification during contact between the glass beads and the rubber of the tire. Because of the conductivity of the rubber, any charge on the tire will be quickly dissipated. However, because of the high surface resistivity of the glass beads, the charge will remain on the glass beads for long periods of time. The result is that the glass beads cling against the lining of the tire at the neutralizing balanced positions. This overall clinging effect is referred as “electrostatic cling”. The glass beads do not disengage from the lining whenever the tire stops motion, because of the force between the charge on the beads and an opposite induced force in the rubber of the tire. When the tire is dismounted the glass beads remain flush against the lining. When the installer strikes the tire or brushes the beads out of the tire or a sudden shock is felt by the tire, then only will the glass beads disengage from the lining and fall free.

Although this balancing material works, the lubricant has a tendency to wear off the glass beads after a time, for example due to abrasion against the tire and centrifuging off by g-forces. The lubricant is also evaporated off the beads, due to the higher temperatures reached inside the tire during use. FIG. 1 shows a partial triboelectric series listing of materials, starting with materials that acquire a positive electric charge when contacted with other materials, and ending with materials which acquire a negative electric charge when contacted with other materials. Going down from the first material in the list, each material charges increasingly more negative, and a material which follows below another material in the list also charges relatively more negative than the “earlier” material. As is shown in FIG. 1, the known glass beads, used to balance larger tires, charge positive, i.e. they acquire a positive electric charge when they rub against the tire. Equally apparent from FIG. 1 is that the rubber material of the inner lining of a typical tire will charge more negative than the glass beads. It is thus believed that there is created an attraction force between the beads and the liner, greater charge translating into a greater force. When the amount of lubricant decreases, as explained above, the amount of electrostatic cling between the beads and the tire liner increases. The free-flowing property of the bead material is deteriorating to a drier material, which clings easier to the tire. Thus, the amount of electrostatic cling produced by a balancing material according to this prior art is ideal for truck tires, but is too large for certain tire balancing applications, as will be described in more detail later.

Therefore, there exists a need to provide an alternative balancing material to overcome at least some of the drawbacks of currently available tire balancing materials.

### DISCLOSURE OF INVENTION

The known balancing material, having glass beads with a possible addition of lubricant, works satisfactorily in its designated application: truck tire balancing. In a truck, the suspension is designed to support heavy loads and stresses, and not primarily to provide a soft ride for the driver and other occupants of the passenger compartment. There are frequent occasions, at low vehicle speed, when the tires are subjected to rather hard impacts, which can dislodge any tire balancing material which is not clinging hard to the inner liner of the tire. The impacts make it easier for the balancing material to flow back into a position in which the tire is balanced, after the material has been dislodged. The amount of cling between the beads and the Inner liner of the tire is too strong for the material to be used successfully in all automobile tire applications (smaller diameter tires), where the centripetal force is much higher than for large diameter tires, and the suspension is designed primarily to soften the ride for the passengers, as well as provide suitable road holding for the vehicle, and there are fewer and much softer impacts on the tire/wheel combination. An average passenger car tire will be subjected to approximately 320 G at 60 mph (96.5 km per hour), whilst a medium truck tire is subjected to approximately 160 G at the same vehicle speed. This makes it harder to readjust and distribute the balancing material in the tire, due to the larger G-forces that have to be overcome. If the balancing material clings too strongly to the tire liner, the material will not be able to flow freely enough to roll to the imbalance location, and the balancing will take longer to be accomplished. Thus, the electrostatic cling between the beads and the tire will have to be regulated and optimised, using a more permanent solution than the suggested addition of a lubricant. The ideal balancing material would balance the tire once, and then cling to this position until it is either dislodged by an unusually large impact at low speed on the tire or when a further imbalance of the tire occurs.

The inventor has found that a balancing material can be made using materials consisting of a material chosen from the more positive end of the triboelectric series, having a coating of a material chosen from the more negative end of the triboelectric series. In this way, the amount of static electricity charge of the balancing material can be regulated, by varying the coating layer thickness, the material used for the coating and the diameter of the more positive material (the bead). Thus, an optimized material can be produced, having the appropriate static electricity charging characteristic for any given tire size and application.

It is thus an object of the invention to overcome at least some of the drawbacks of the currently available balancing materials by providing a balancing material which can be given the appropriate static electricity charging characteristic for any given tire size and application.

It is another object of the invention to provide a balancing material having little moisture absorption characteristics.

It is another object of the invention to provide a balancing material having low deterioration characteristics, to minimize the dust production inside the tire.

It is another object of the invention to provide a balancing material having a non-abrasive characteristics when in use within a tire.

It is another object of the invention to provide a balancing material not having an adverse reaction to contact with metal or rubber.

In the invention, a vehicle tire balancing material is used, the material comprising beads formed from a first material having a higher tribo-electric work function. The beads have a permanent coating formed from a second material having a lower tribo-electric work function.

The first material is preferably selected from the group of glass (quartz), nylon, acetate, lead, aluminum and steel.

The first material is most preferably glass (quartz).

The second material is preferably selected from the group of Silicone rubber, Silene, Teflon, Silicon, KEL F, PVC, Polypropylene, Polyethylene, Polyurethane, Saran, Acrylic, Orion, Styrene, Celluloid Polyester, Acetate, Rayon, steel, nickel, copper and brass.

The second material is more preferably selected from the group of Silene, Teflon, and Silicon.

In one embodiment of the invention, the second material is Teflon.

In a further embodiment of the invention, the second material is Silicon.

In still a further embodiment of the invention, the second material is Silane.

Advantageously, the beads are rounded and generally spherical in shape.

Preferably, the beads are in the range between 25 to 45 thousands of an inch (0.64 to 1.15 mm) in diameter.

According to a first embodiment of the invention, a method of correcting the imbalance in a wheel assembly comprises the steps:

(a) injecting a desired amount of a vehicle tire balancing material comprising beads formed from a first material having a higher tribo-electric work function, the beads having a permanent coating formed from a second material having a lower tribo-electric work function into the hollow interior of a stationary tire mounted to a wheel rim,

(b) pressurizing the air in the tire to a desired level,

(c) setting in motion the tire, causing the tire balancing material to migrate within the interior of the tire and to generally come to a stop on the lining of the tire at a position or positions so as to counterbalance the imbalance in the wheel assembly and remaining at those positions by electrostatic cling.

According to a second embodiment of the invention, a method of correcting the imbalance in a wheel assembly comprises the steps:

(a) introducing a predetermined amount of a vehicle tire balancing material comprising beads formed from a first material having a higher tribo-electric work function, the beads having a permanent coating formed from a second material having a lower tribo-electric work function into the tire well of an unmounted stationary tire,

(b) mounting the tire,

(c) pressurizing the air in the tire to a desired level, and

(d) setting in motion the tire, whereby the tire balancing material migrates within the interior of the tire and comes to a stop on the lining of the tire at a position or positions so as to counterbalance the imbalance in the wheel assembly.

According to a third embodiment of the invention, a method of correcting the imbalance in a wheel assembly comprises the steps:

(a) introducing into a well of a tire prior to the tire being mounted at least one pressurized sealed package containing therein a predetermined amount of a vehicle tire balancing material comprising beads formed from a first material having a higher tribo-electric work function, the beads having a permanent coating formed from a second material having a lower tribo-electric work function,

(b) inflating the tire to a desired pressure level and such a way so as to break open the sealed package whereby the tire balancing material is released into the tire well, and

(c) setting in motion the tire whereby the released tire balancing material migrates within the inner periphery of the tire and comes to a stop on the lining of the tire at a position or positions so as to counterbalance the imbalance in the wheel assembly.

The inflation step is advantageously achieved by using an air bead blaster device.

Preferably, the package material comprises polyvinyl chloride material, cellophane material or polyethylene material.

Advantageously, the desired amount of vehicle tire balancing material is one ounce (28.35 g) of beads for every 13 pounds (5.9 kg) of weight of the tire.

Further features of the invention will be described or will become apparent in the course of the following detailed description.

### BRIEF DESCRIPTION OF DRAWINGS

In order that the invention may be more clearly understood, the preferred embodiment thereof will now be described in detail by way of example, with reference to the accompanying drawings, in which:

FIG. 1 is a listing of materials in a triboelectric series,

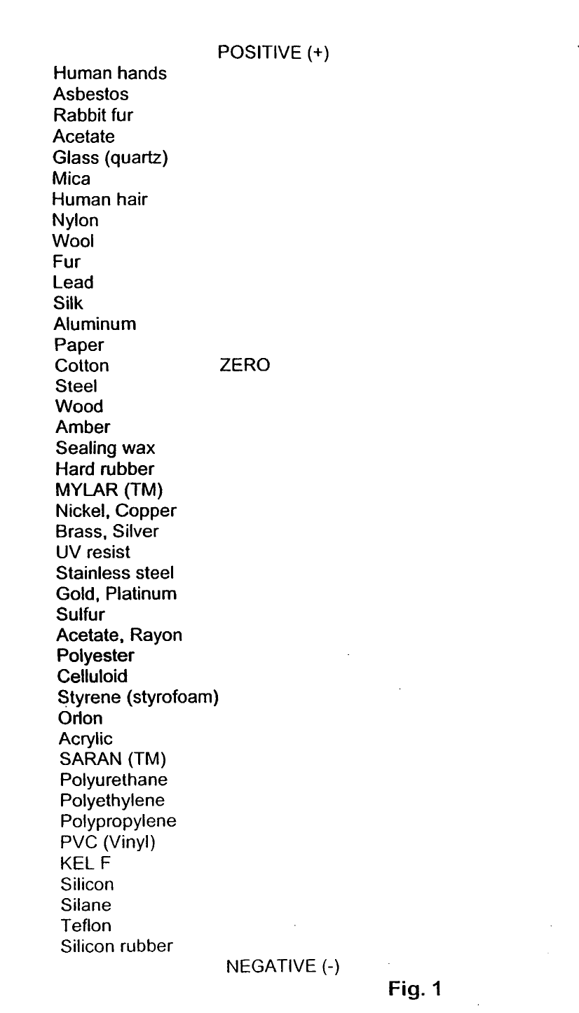

FIG. 2 is a sectioned view of a coated bead according to the invention,

FIG. 3 is a cross-sectional view of a tire with the glass beads being injected inside of the tire,

FIG. 4 is a side view of a wheel assembly illustrating a heavy spot and the approximate location of the counterbalancing glass beads, and

FIG. 5 is an elevational side view of a tire balancing material application bag according to the invention.

### BEST MODE FOR CARRYING OUT THE INVENTION

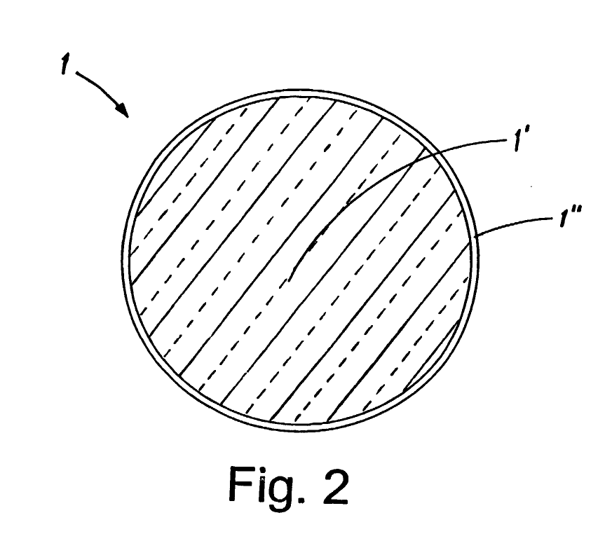

The accompanying drawings illustrate the invention. As is shown in FIG. 2, a balancing bead 1 according to the invention is generally spherical and has a coating 2 covering substantially all of the bead. A larger bead diameter results in a smaller ratio of surface area to total weight of the bead (with coating). Thus, a larger bead shows less cling to the tire liner than a smaller bead (with a larger ratio of surface area to weight). In a typical automobile tire application, diameters of around 45 thou (1.15 mm) have been found to be optimal. Prior art beads were seldom larger than 25 thou (0.64 mm). Better control over the clinging properties can be had by varying the bead diameter, coating thickness and coating material. It is also conceivable to use other material than glass (quartz) for the bead, but the general requirements are cost, specific weight and position in the triboelectric series for the specific material. A material that is light, but otherwise suitable, will be required in a larger volume, to balance a tire. A material that is heavy, might be prohibitively too expensive.

Suitable bead materials are glass (quartz), nylon, acetate, lead, aluminum and others who are found in the more positive end of the triboelectric series. Due to its specific weight, low cost and ease of manufacturing (also in spherical shape), glass is the preferred material for the bead.

The coating is preferably baked or hardened on, to produce a coating which is durable and crack-resistant. By baking or hardening the coating, evaporation of the coating material is largely prevented later in the tire, and the coating will better resist abrasion and centrifugal losses of material. The coating material has to be chosen for its triboelectric properties, as well as its mechanical properties. Advantageous choices for coating material has been found in the group consisting of Silicon rubber, Teflon (TM), Silicon, Silane, KEL F (TM), PVC (vinyl), Polypropylene, Polyethylene, Polyurethane, Saran (TM), Acrylic, Orlon (TM), Styrene, Polyester, Acetate, Rayon (TM). Possible use can also be had from metal coatings by such metals as steel, nickel, copper and brass, but the cost of producing these coatings might be prohibitive. The preferred materials for the coating are Teflon (TM), Silane and Silicon. KEL F is also known under the name CTFE (chlorotrifluoroethylene). Silane is silicon tetrahydride. Styrene is also known under the following names vinylbenzene, ethenylbenzene, cinnamene and phenylethylene. Styrene can also be used in its polystyrene form, or mixed monostyrenelpolystyrene.

The coating material is either baked on the beads, for example Teflon can be baked on glass beads at approximately 350 deg. F. (177 deg. C.) for approximately 10 minutes. The fumes coming from the heating process are toxic, and should preferably be cleaned in scrubbers. Alternatively, a hardener can be mixed with the coating material, which is then applied to the beads and allowed to harden. This latter method can be used for Silane, for instance.

Depending upon the coating process, beads that are not spherical can be used, as long as the coated bead has taken a more spherical shape (after the coating is applied).

A mix of smaller diameter beads and larger diameter beads can be used to cover a larger tire diameter variation in the applications.

By varying the coating material and thickness, a standard size of large diameter beads may be used to balance tires of a large variety of sizes. This will cut the manufacturing costs of the balancing material, since only one size bead will be necessary to produce and stock.

Advantageously, the beads do not react to any metal or alloyed metal wheel. The very good durability characteristics of the beads lead to little deterioration of the material into dust particles. This in turn reduces the possibility of the tire valve seat from clogging. Moreover, the present invention is environmentally friendly. Unlike some traditional lead-based balancing materials, escape or release of the beads into the environment will not be detrimental thereto.

Additionally, the bead balancing material has shock absorbing characteristics. The inventor has observed that, with the bead material installed, a noticeable reduction of vibration from the bumpy ride from a rough road or tight turns is achieved.

If the application of the beads is to be via the valve stem of a tire mounted onto a wheel, the maximum diameter for the bead is determined by the inner diameter of the valve stem (valve core removed). If beads of too large diameter are inserted, they tend to get stuck at the entrance to the valve stem (queuing problems). Thus, bead diameters of between 25 and 45 thou (0.64 to 1.15 mm) are preferred, but in certain special applications, larger bead diameters may be used.

With reference to FIG. 2, the tire balancing beads are preferably substantially spherical in shape. The tire balancing material 1 has beads 1′ with a coating 1″. The balancing material is initially free-flowing, and is introduced into the hollow interior of a tire 2 preferably by one of five methods.

In the first method (first embodiment of the invention), a desired amount of glass beads may be poured into the tire well before the tire is mounted onto the wheel (not shown). The tire is then inflated after mounting.

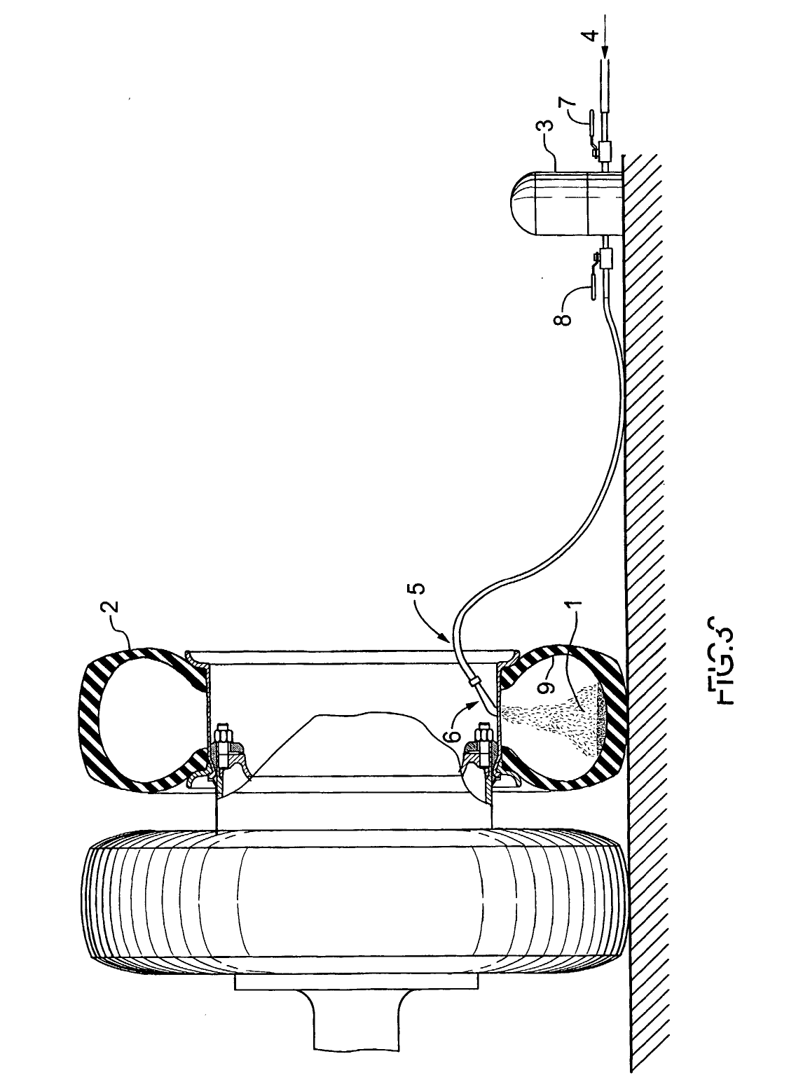

In the second method (second embodiment of the invention), as shown in FIG. 3, a pre-mounted tire is half deflated, and an in-line applicator 3 Is filled with the desired amount of the balancing material. An air intake end 4 of the applicator is connected to a typical pressurized tire air supply. Further, an air exit 5 is connected to a tire valve 6 connector. An inlet valve 7 is next opened, thereby pressurizing the applicator. An outlet valve 8 is subsequently opened, and approximately thirty seconds later the balancing material is completely injected into the tire 9. The in-line applicator 3 is slowly flipped upside down. The tire may then continue to be inflated to a desired tire pressure, for instance up to 150 psi (10.2 atm).

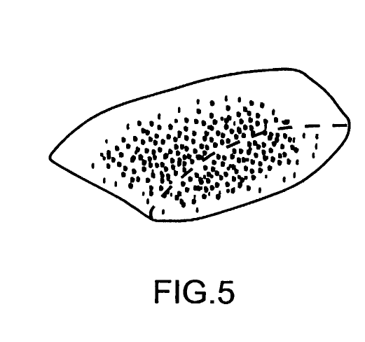

In the third, fourth, and fifth methods (third embodiment of the invention), a slightly pressurized (approximately 0.5 psi or 0.34 atm) sealed package (see FIG. 5) containing a predetermined amount of the tire balancing material is placed into the tire well/cavity of a tire prior to mounting the tire. The package is, preferably, potato chip bag-like in shape. The tire containing the package therein is then inflated to a desired pressure. Since the pressure in the inflated tire is much higher (i.e. 25 to 150 psi, or 1.7 to 10.2 atm) than the package, the package will burst or collapse under pressure and release the balancing material into the tire. To assure the collapse of the package and the release of the balancing material, rapid inflation of the tire is desired. In a preferred embodiment, an air bead blaster is utilized to pressurize and seat the tire. The bursted package and balancing material would then be forced to the inside liner of the tire through centrifugal force, as described below, as the tire begins to roll. Methods three through five are ideally suited for use in situations where there is a high volume of tires to be balanced and the completion time for installing the balancing material is important, such as in OEM assembly lines and/or where the use of air bead blaster is utilized to inflate a tire from the bead seating area of the tire. Methods three and four differ in the choice of packaging material used.

In the third method, a polyvinyl chloride package having a high contact electrification allowing it to also cling to the inside liner of the tire is used. In a preferred embodiment, the polyvinyl chloride packaging would be made from one thousandths of an inch thick material (0.025 mm). Due to the relatively high running temperature of the tire the package will eventually shrink and partly dissolve while the balancing material is still effective in balancing the tire.

In contrast, the fourth method uses a package made of cellophane, or other paper material, that eventually breaks down into a dust. This latter method is not as desirable as the third method, because as previously mentioned dust is not desirable. Dust would then call for a valve filter to be used.

In the fifth method, the packaging is made from polyethylene, preferably one thousandths of an inch (0.025 mm) in thickness. In this embodiment of the invention, the package material shrinks, and bonds to the tire lining with the combination of centripetal force and heat.

Other packaging materials would also be suitable so long as the proposed material breaks down or bonds with the lining of the tire without leaving substantial dust particles and is environmentally friendly.

The application amount of the glass beads varies according to the size of the tire. In general, for every 13 pounds (5.9 kg) of tire, 1 ounce (28.35 g) of glass beads should be introduced into the tire. A typical car tire will weigh about 30 pounds (13.6 kg) while a light truck tire will weigh 40 to 50 pounds (18.1 to 22.7 kg) and a medium truck tire will weigh about 90 to 130 pounds (40.8 to 59 kg). It should be noted that up to twice the suggested amount (or possibly more, cost permitting) may be used where necessary to balance the tires.

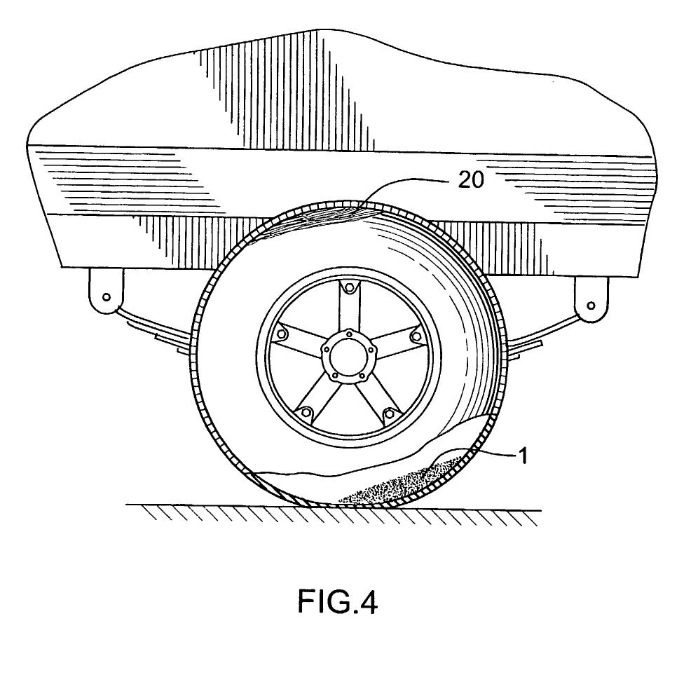

For illustrative purposes FIG. 4 shows a shaded heavy spot 20 and the approximate location of the coated beads 1 to counterbalance the imbalance in the wheel assembly. The heavy spot 20 on the wheel assembly results in a centripetal “G” force which compresses the suspension springs of the vehicle creating an up and down bouncing effect (a vibration). This constant force is enough to gradually move the beads in the opposite direction of the heavy spot through inertia until it has counteracted the imbalance and the glass beads hold their position, this latter feature is referred herein as electrostatic cling. This electrostatic cling characteristic of the glass beads constitutes a major deviation from traditional balancing materials. Traditional balancing materials, having a composition that inherently prevents electrostatic cling from occurring, remain free-flowing. In complete contrast, the present invention utilizes the electrostatic cling effect to produce some of the advantages described above that flow from this balancing material. The electrostatic cling prevents substantial wear and tear on the material by reason of it not having to continually go through re-balancing after each stopped position of the vehicle and thus provides less wear and tear on the vehicle itself, less vibration, a smoother ride resulting in a safer vehicle, and a substantially constantly balanced tire at all speeds.

It will be appreciated that the above description relates to the preferred embodiment by way of example only. Many variations on the invention will be obvious to those knowledgeable in the field, and such obvious variations are within the scope of the invention as described and claimed, whether or not expressly described.

For example, composite materials, i.e. mixes of two or more from the earlier described groups of materials, may be used as bead material, or as coating material, as long as the earlier described general requirements regarding material properties are adhered to.

Industrial Applicability

The invention provides a improved tire balancing material.

1. A vehicle tire balancing material comprising beads formed from a first material having a higher tribo-electric work function than the tire material, said beads having a permanent coating formed from a second material having a lower tribo-electric work function than said first material.

2. A balancing material as claimed in claim 1, where said first material is selected from the group of glass (quartz), nylon, acetate, lead, aluminum and steel.

3. A balancing material as claimed in claim 2, where said first material is glass (quartz).

4. A balancing material as claimed in any of claims 1 to 3, wherein said second material is selected from the group of Silicone rubber, Silene, Teflon, Silicon, KEL F, PVC, Polypropylene, Polyethylene, Polyurethane, Saran, Acrylic, Orion, Styrene, Celluloid Polyester, Acetate, Rayon, steel, nickel, copper and brass.

5. A balancing material as claimed in any of claims 1 to 3, wherein said second material is selected from the group of Silene, Teflon, and Silicon.

6. A balancing material as claimed in any of claims 4 or 5, wherein said second material is Teflon.

7. A balancing material as claimed in any of claims 4 or 5, wherein said second material is Silicon.

8. A balancing material as claimed in any of claims 4 or 5, wherein said second material is Silane.

9. A balancing material as claimed in any of claims 1 to 8, wherein said beads are rounded and generally spherical in shape.

8. A balancing material as claimed in any of claims 1 to 9, wherein said beads are in the range between 25 to 45 thousands of an inch (0.64 to 1.15 mm) in diameter.

9. A method of correcting the imbalance in a wheel assembly comprising the steps:
(a) injecting a desired amount of a vehicle tire balancing material comprising beads formed from a first material having a higher tribo-electric work function, said beads having a permanent coating formed from a second material having a lower tribo-electric work function into the hollow interior of a stationary tire mounted to a wheel rim,
(b) pressurizing the air in the tire to a desired level,
(c) setting in motion the tire, and
(d) the tire balancing material migrating within the interior of the tire and coming to a stop on the lining of the tire at a position or positions so as to counterbalance the imbalance in the wheel assembly and remaining at those positions by electrostatic cling.

10. The method claimed in claim 9, wherein the desired amount of vehicle tire balancing material is one ounce (28.35 g) of beads for every 13 pounds (5.9 kg) of weight of the tire.

11. A method of correcting the imbalance in a wheel assembly comprising the steps:
(a) introducing a predetermined amount of a vehicle tire balancing material comprising beads formed from a first material having a higher tribo-electric work function, said beads having a permanent coating formed from a second material having a lower tribo-electric work function into the tire well of an unmounted stationary tire,
(b) mounting the tire,
(c) pressurizing the air in the tire to a desired level, and
(d) setting in motion the tire, whereby the tire balancing material migrates within the interior of the tire and comes to a stop on the lining of the tire at a position or positions so as to counterbalance the imbalance in the wheel assembly.

12. The method claimed in claim 11, wherein the desired amount of vehicle tire balancing material is one ounce (28.35 g) of beads for every 13 pounds (5.9 kg) of weight of the tire.

13. A method of correcting the imbalance in a wheel assembly comprising the steps:
(a) introducing into a well of a tire prior to the tire being mounted at least one pressurized sealed package containing therein a predetermined amount of a vehicle tire balancing material comprising beads formed from a first material having a higher tribo-electric work function, said beads having a permanent coating formed from a second material having a lower tribo-electric work function,
(b) inflating the tire to a desired pressure level and such a way so as to break open said sealed package whereby said tire balancing material is released into the tire well, and
(c) setting in motion the tire whereby the released tire balancing material migrates within the inner periphery of the tire and comes to a stop on the lining of the tire at a position or positions so as to counterbalance the imbalance in the wheel assembly.

14. A method of balancing a wheel assembly as claimed in claim 13, wherein said inflation step is achieved by an air bead blaster device.

15. A method of balancing a wheel assembly as claimed in claim 14, wherein the package material comprises polyvinyl chloride material.

16. A method of balancing a wheel assembly as claimed in claim 14, wherein the package material comprises cellophane material.

17. A method of balancing a wheel assembly as claimed in claim 14, wherein the package material comprises polyethylene material.
